(19) United States
(12) Patent Application Publication
(10) Pub. No.: US 2004/0250523 A1
(43) Pub. Date: Dec. 16, 2004

(54) Feeder roller

(76) Inventor: Steven Theodore Schulz, Horsham (AU)

Correspondence Address: STANDLEY LAW GROUP LLP, 495 METRO PLACE SOUTH, SUITE 210, DUBLIN, OH, 43017, US

(21) Appl. No.: 10/865,468

(22) Filed: Jun. 10, 2004

(30) Foreign Application Priority Data
Jun. 12, 2003 (AU) 2003902952

(51) Int. Cl. A01D 46/08

(52) U.S. Cl. 56/153

(57) ABSTRACT

The present invention relates to a feeder roller used in agricultural machinery which facilitates the feeding of an object or item from a first location to a second location. The feeder roller is rotatable about an axis of rotation, and has an outer surface which includes at least one projection which extends a predetermined distance from the outer surface in an outwardly direction away from the axis of rotation. The projections of the feeder roller add motion to any item the projections contact when the feeder roller is rotating about the axis of rotation. In a preferred embodiment of the invention, the feeder roller is used in an elevator of a combine harvester, resulting in improved feeding characteristics.

### THE FIELD OF THE INVENTION

The present invention relates to a feeder roller for use in agricultural machinery. More particularly, the present invention relates to a feeder roller used in agricultural machinery which facilitates the feeding of an object or item from a first location to a second location.

The invention will herein after be described in the context of a combine harvester. However, it is to be understood that the invention can have a broader application and can be used in any agricultural machinery which use a similar feeder roller to help transport an object from a first location to a second location.

### BACKGROUND TO THE INVENTION

A combine harvester is a harvesting machine which reaps and threshes crops, particularly grain crops such as wheat, barley, rye and oats, sorghum, soybeans or other dry beans, corn, rice, seeds or the like. To harvest a crop, a combine harvester cuts the crop close to the ground using a series of blades horizontally spaced along a broad area in front of the harvester. The cut crop is collected into a rotating shaft or auger, which laterally compacts the cut crop towards the centre of the auger. Thereafter, the compacted cut crop is fed to an elevator. The elevator is used to transport cut crop exiting the auger, along an enclosed chute and into a processing section of the combine harvester.

The elevator typically includes at least two rollers, being a first and second roller, connected using a number of continuous belts or chains. Typically, the belts or chains have several spaced apart rectangular members running parallel to the rollers and perpendicular to the belt or chains, connecting the chains together. One of the rollers, typically the second roller, is driven by a motor. Movement of the motor driven roller rotates the chains and members around the rollers and along the elevator chute.

The cut crop is typically fed to one side of the elevator closest to the first roller. The continuous movement of the rectangular members around the first roller compresses the cut crop between a member underneath the roller and the elevator chute floor. Progression of the member along the elevator forces the cut crop to travel along the length of the elevator. The amount of crop which can travel along the elevator is limited by the dimensions of the gap between the rectangular members and the elevator chute floor (“the gap”). This is effectively the bottle-neck of the harvesting process.

It has been found that when harvesting heavily distributed crops that the cut crop tends to build up at this bottle-neck. The build up of cut crop can block the gap. Furthermore, if the crop is able to fall back (is back-fed) to the auger, the cut crop can cycle between the auger and the first feeder roller. Accordingly, harvesting is slower, because more time needed to transfer the cut crop from the auger to the processing section of the combine harvester. Therefore, blockage of the gap and back-feeding reduce the effectiveness and efficiency of the elevator.

Accordingly, it would be advantageous to include a means within the elevator which helps to prevent blockage of the gap and/or reduces back-feeding.

For the purposes of this specification, the term “projection” or “projections” is intended to include all types of protrusions including bumps, lumps, knobs, flanges, lips, arches, cambers, pyramids, spigots, outcrops, outgrowths, juts, jags, snags, ledges, shelves or the like. Furthermore, the term “feeder roller” is intended to include all forms of elongated members capable of rotating about an axis of rotation.

### SUMMARY OF THE INVENTION

According to one aspect of the present invention there is provided a feeder roller for agricultural machinery which facilitates the feeding of an object or item from a first location to a second location, the feeder roller being rotatable about an axis of rotation and having an outer surface which includes at least one projection which extends a predetermined distance from the outer surface in an outwardly direction away from the axis of rotation.

Accordingly, the feeder roller of the present invention is able add motion to any object or item contacting the projection or projections when the feeder roller is rotating about the axis of rotation.

Preferably, the outer surface includes a plurality of projections. Preferably, the projections are distributed over the entire outer surface of the feeder roller. More preferably, the projections are evenly distributed over the outer surface of the feeder roller.

In one embodiment of the invention, the surface of the feeder roller includes an array of the projections. Preferably, the array is a regular array of projections. More preferably, the array is a regular repeating array of projections. Preferably, the projections all have substantially the same dimensions. Preferably, the projections are elongated. More preferably, the projections substantially extend across the breadth of the feeder roller.

The projection(s) can be any type of protrusion. Preferably, the projection(s) are formed of geometric bodies, preferably regular geometric bodies. Preferably, the geometric bodies are selected from prisms, cubes, pyramids, tetrahedrons, parallelepipeds, frustums, cylinders, segments of spheres or spheroids or combinations thereof. Most preferably, the projections are rectangular parallelepipeds.

In an embodiment of the present invention, the projections are shaped so as to include teeth. More preferably, the teeth are square teeth.

Preferably, the feeder roller comprises an elongated section rotatable about an axis of rotation. Preferably, the elongated section is in the shape of a regular geometric body. Preferably, the geometric body is substantially symmetrical about the axis of rotation. More preferably, the elongated section is selected from a cylinder, parallelepiped or prism having a length parallel with the axis of rotation. Most preferably, the elongated section is a prism.

Preferably, the elongated section is a prism having a cross-section substantially in the shape of a regular polygon such as a triangle, square, rectangle, pentagon, hexagon or heptagon. Preferably, the prism has a substantially triangular cross-section.

Preferably, the feeder roller further comprises at least one actuating section by which the feeder roller can be rotated. The actuating section preferably comprises at least one belt or chain driven section. Preferably, the belt or chain driven section includes at least one cylindrical section perpendicular to the axis of rotation such that the axis of symmetry of the cylindrical section is equivalent to the axis of rotation of the feeder roller. Preferably, the feeder roller includes 2, 3, 4 or 5 cylindrical sections.

In one embodiment of the present invention, the cylindrical section further comprises a circumferential face having a groove or channel. Preferably, the groove or channel extends substantially around the circumference of the circumferential face. Preferably, the channel is concave. Preferably, groove or channel is adapted to engage the belt or chain of the actuating section.

In another embodiment of the present invention, the belt or chain driven section can also further comprise a material insert or coating. Preferably, the insert is housed within a groove or channel within the circumferential face of the cylindrical section. Preferably, the material insert is used to dampen any noise caused by the belt or chain engaging the chain driven section.

In one embodiment of the present invention, the feeder roller comprises at least three substantially planar members which extend lengthwise around the axis of rotation forming vertices of a prism. Typically, each planar member includes at least two spaced apart intersection locations parallel to the axis of rotation in which part of one planar member intersects with a part of another planar member. Preferably, the planar members meet at a peak or point at the intersection location and thereby form a projection. Preferably, each intersection location of the present invention forms a projection. More preferably, at least one projection is formed by a planar member extending a predetermined distance beyond the intersection location in an outwardly direction away from the axis of rotation. More preferably, all of the projections are formed by a planar member extending a predetermined distance beyond the intersection location in an outwardly direction away from the axis of rotation.

In another embodiment of the invention, the feeder roller of the present invention further includes attachable covers. Preferably, the covers attach along the length of the feeder roller. Preferably, covers attach to the feeder roller so as to form a substantially cylindrical cover. Preferably, at least one projection extends a predetermined distance, in an outwardly direction from the axis of rotation, beyond the cover's outer circumference.

The feeder roller of the present invention is preferably used in a combine harvester. More preferably, the feeder roller of the present invention is used as a roller in an elevator of a combine harvester. In this embodiment, the feeder roller results in improved feeding characteristics for the combine harvester.

### BRIEF DESCRIPTION OF THE DRAWINGS

The present invention will now be described with reference to the figures of the accompanying drawings, which illustrate particular preferred embodiments of the present invention, wherein:

FIG. 1 is perspective view of a combine harvester in which the centre section of the rotating reel and the roof of the elevator chute have been omitted so as to more clearly illustrate the external parts of the combine harvester.

FIG. 2 is a sectional elevation view along the line 2-2 of FIG. 1 showing the auger and elevator detail of the combine harvester having a feeder roller of the present invention.

FIG. 3 is a perspective view of the feeder roller of the present invention in situ within the elevator mechanism and elevator chute of one type of combine harvester. The top wall and side wall of the elevator chute are fragmented for illustrative purposes.

FIG. 4 is a side elevation view of one embodiment of the feeder roller of the present invention, showing one particular configuration of the projections.

FIG. 5 illustrates a side elevation of one embodiment of the present invention in which the projections extends beyond the outer circumference of the cylindrical actuating sections.

FIG. 6 is a sectional elevation view of one form of the feeder roller of the present invention, showing the internal details of the feeder roller.

FIG. 7 is a front elevation view of one embodiment of the planar members of the present invention in which the projections include teeth.

FIGS. 8a, 8b and 8c illustrate various embodiments of the present invention having two or three actuating sections.

FIG. 9 illustrates one section of an embodiment of the present invention which includes an insert within a channel in the actuating section, on which the chain or belt can engage.

FIG. 10 illustrates a sectional side elevation of an embodiment of the present invention including attachable covers, which attach around the planar members to form a cylinder.

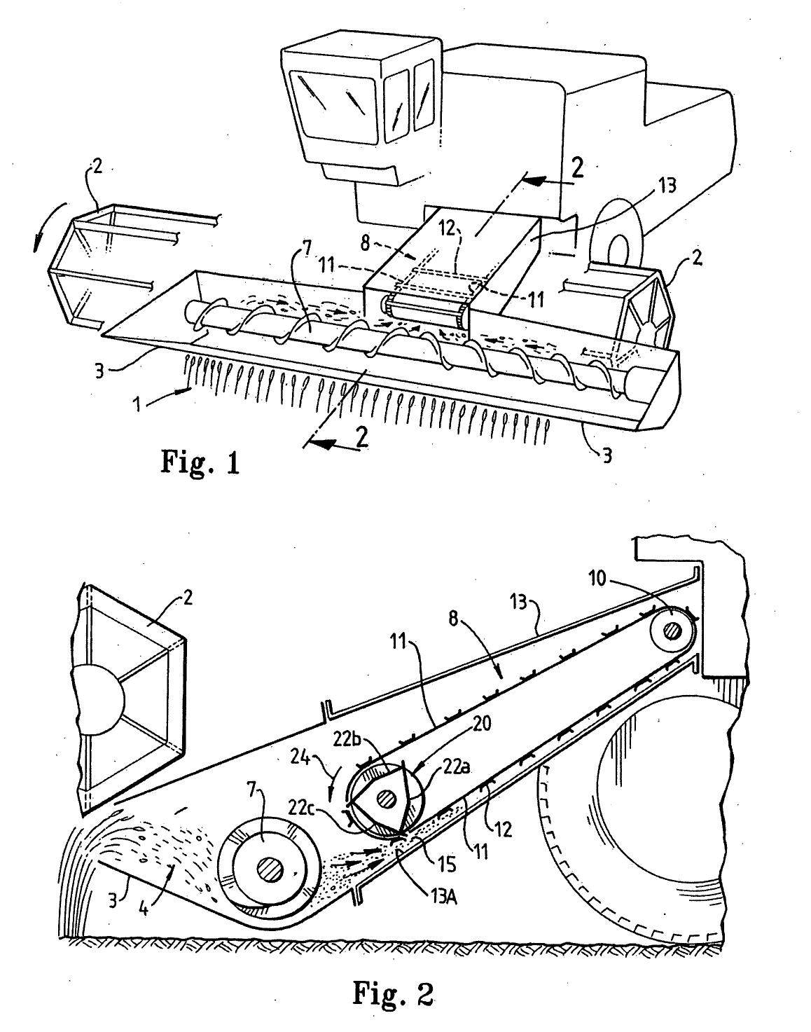

The configuration of a typical combine harvester is illustrated in FIG. 1. Crops 1 are harvested using a large rotating reel 2 to fold the crop 1 over a cutter bar 3 which cut the crop 1 at a location close to the ground. The cut crop 4 travels from the rotating reel 2, along a rotating auger 7 and an elevator 8. The feeder roller of the present invention is preferably used as the first feeder roller 20 of the elevator 8.

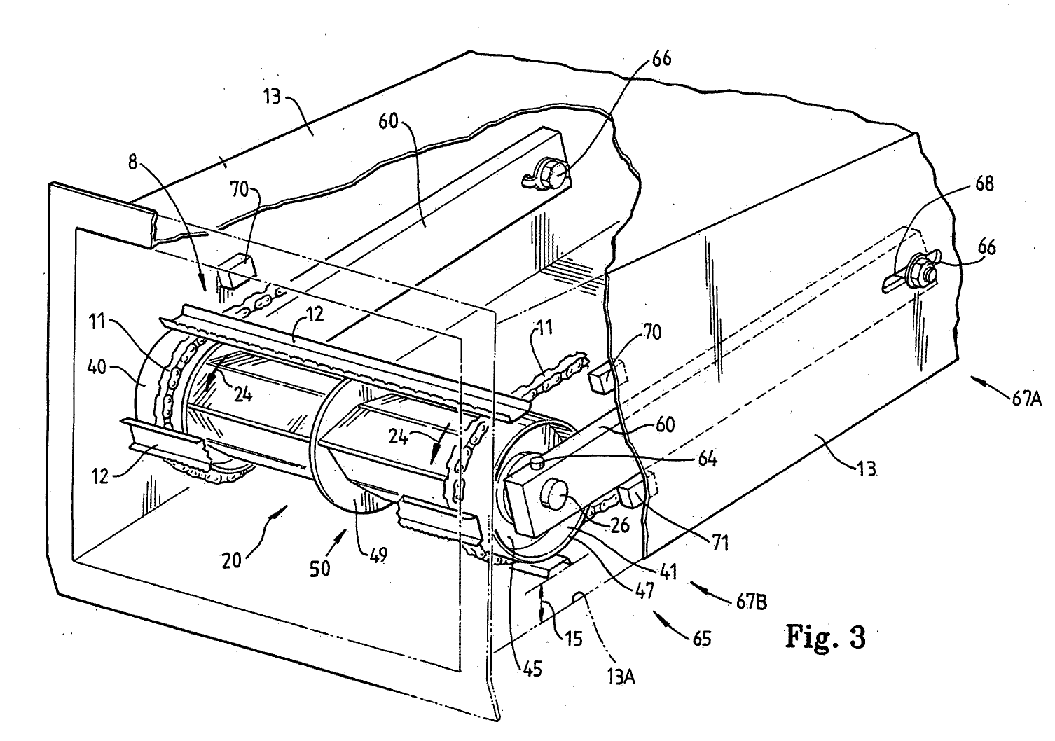

The details of the elevator 8 are shown in FIG. 3. The elevator 8 is housed in an elevator chute 13. The elevator 8 typically includes at least two rollers 10 and 20 having drive sprockets which are connected by two parallel spaced apart belts or chains 11. At least one of the rollers 10 or 20 is rotated by a motor, in this case the rear roller 10. The other roller, in this case the front roller 20, is free rotating, and is therefore rotated by engagement of the moving chain 11 on the surface of two cylindrical reels 40, 41. Movement of the motor driven rear roller 10 continuously rotates the chains and front roller 20, according to FIGS. 2 and 3, in an anticlockwise direction.

A plurality of parallel spaced apart flat members or slats 12 perpendicularly connect the two spaced apart chains 11. The slats 12 extend around the entire perimeter of the chains. Movement of the motor driven rear roller 10 rotates the chains 11 and slats around the rollers 10 and 20 and along the elevator chute 13. Lateral movement of the chains 11 is limited by tension of the chains 11 around the two rollers 20 and 10, the space apart connection to the slats 12 and the proximity of the side walls of the elevator chute 13.

The feeder roller 20 is typically mounted on a suspension system shown in FIG. 3. The suspension system consists of two cantilever beams 60, bolted at one end 67A to the sides of the elevator chute 13 up stream of the feeder roller 20 and having the feeder roller 20 mounted at the other end 67B. The cantilever beams 60 are two elongated rectangular parallelepiped beams. An axle 26 extending through the feeder roller 20 is mounted into a corresponding recess or hole 41 at the free end 67B of two cantilever beams 60. The axle 26 is secured within the hole 41 using a pin 64 which projects through the top of the end of the cantilever beam 60 and through the axle 26. The gap 15 between the base of the elevator chute 13A and feeder roller 20 can be adjusted by lifting or lowering the unsecured end 65 of the cantilever beams 60. The maximum and minimum heights that the beams 60 can be moved are limited by stoppers 70 and 71, which are secured to the walls of the elevator chute 13. The stoppers 70 and 71 are typically cube shaped blocks bolted into the walls of the elevator chute 13. The tension of the chain 11 between the rollers 20 and 10 can be adjusted by adjusting the position of the bolt 66 in a horizontal slot 68 in which the bolt 66 is secured.

The feeder roller 20 is connected to the suspension system via an axle 26. The axle 26 extends lengthwise along the axis of rotation, through the entire length of the feeder roller 20, including the two sections which comprises the feeder roller 20, being:

two cylindrical actuating sections or reels 40 and 41, which engage two chains 11 driven by the second motor driven roller 10 so as to rotate the feeder roller 20.

an elongated section 50, which can contact the cut crop 4 exiting the auger 7. The surface of the elongated section contains projections 29a, 29b and 29c.

The two cylindrical reels 40, 41 are fixedly attach to the ends of the elongated section in locations which ensure that both the elongated section 50 and reels 40 and 41 share the same axis of rotation 24. The elongated section 50 may be affixed to the reels 40 and 41 using any suitable technique known to persons skilled in the art. Suitable techniques include welding, bolting, gluing, or integrally casting the entire structure.

The cylindrical reels 40 and 41 comprise an outer tubular rim 47 affixed to an inner circular disc 45. The disc 45 is orientated perpendicular to the axis of rotation 24, having a centre at the axis of rotation 24. The disc 45 is constructed of at least 2 mm thick material. The rim 47 is a cylindrical tube having an inner diameter equal to the outer diameter of the disc 45 and a wall thickness of at least 2 mm. The width of the rim 47 lengthwise along the axis of rotation 24 is at least half the diameter of the disc 45. The rim 47 is fixedly secured to the disc 45 at the middle of the lengthwise width of each rim 47. The rim 47 may be affixed to the disc 45 using any suitable technique known to a person skilled in the art. Suitable techniques include welding, melting or integrally casting the rim 47 and disc 45.

The feeder roller 20 is mounted on the axle 26 using bearings 54, preferably flange bearings, mounted on the external surfaces 52a and 52 of the reel discs 45. The bearings 54 are typically bolted 32 to the reel discs 45. The axle 26 extends lengthwise along the axis of rotation 24, through the centre of each of the reels 40, 41 and through the entire length of the elongated section 50, extending beyond the external side 52a and 52b of the reel discs 45, and beyond the outer edges of the rim discs 54.

As shown in FIG. 3, a circular flexibility disc 49 can also be included at the middle of the elongated section 50. The flexibility disc 49 is constructed of a circular sheet having a thickness of at least 5 mm, and having the same diameter as the outer diameter of each reel 40, 41 and is preferably of a rigid construction. The flexibility disc 49 may be fixedly secured around the outside of the elongated section 50, or bisect the elongated section 50 in two, such that the elongated section 50 is formed of two sections which can be affixed, by for example welding, to each side of the flexibility disk 49 perpendicular to the axis of rotation 24. The purpose of the flexibility disc 49 is to prevent excessive flexing of the slats 12 at the centre of the elongated section 50, when the slats 12 rotate around the feeder roller 20.

The effectiveness of the feeder roller 20 in preventing blockages at the start of the elevator 8 and/or reducing back-feeding is dependent on the shape and configuration of the projections 29a, 29b and 29c and/or on the shape elongated section 50.

The illustrated elongated section 50 consists of three bent or arcuate rectangular planar sheets 22a, 22b and 22c arranged equidistant around an axis of rotation 24. Each planar sheet 22a, 22b and 22c consists of flat rectangular sheets 23a and 23b connected at an angle 27 of about 160° to each other. The angle 27 is positioned inside the cross-sectional area of the elongated section 50. One edge of each planar sheet 22a, 22b and 22c parallel to the axis of rotation intersects with the underside of the adjacent planar sheet, so as to form three intersection locations 28a, 28b and 28c. The edge of the planar sheet 29a, 29b or 29c which is not secured to the under side of the adjacent planar sheet 29a, 29b or 29c extends a predetermined distance beyond the intersection location 28a, 28b and 28c in an outwardly direction away from the axis of rotation 24. This results in “projections” 29a, 29b and 29c of each of the planar sheets 22a, 22b and 22c respectively.

Two embodiments of the elongated section 50 are possible depending on the orientation of the intersection locations 28a, 28b and 28c with respect to the direction of rotation 24 of the feeder roller 20. The first embodiment, illustrated in FIG. 3, has the underside of the projections 29a, 29b and 29c rotating in the same direction as the direction of rotation 24. The second embodiment, has the top face of the projections 29a, 29b and 29c rotating in the opposite direction 30 as the direction of rotation 24.

The length of the projections 29a, 29b and 29c is dependent on the dimensional constraints of the intended use, the intended purpose of the feeder roller, and/or the method of construction of the feeder roller.

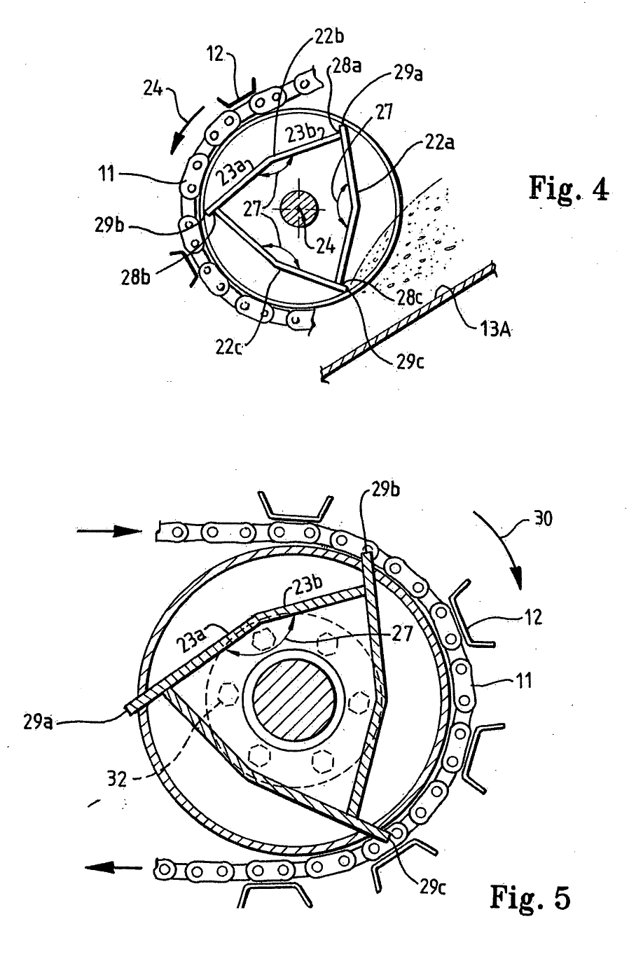

Different embodiments of the present invention with differing projection lengths are shown in FIGS. 4 and 5. In the illustrated embodiments of the feeder roller, the length of the projections 29a, 29b and 29c are limited by the circumference of a cylinder defined by the top of the chain 11 when positioned on top of the reels 40 and 41. If the projections 29a, 29b and 29c extended beyond this circumference, the projections 29a, 29b and 29c could possibly impact the slats running on top of the chains. Obviously, the minimum length of the projections 29a, 29b and 29c is defined by a circumference of a cylinder having a radius defined between the intersection locations 28a, 28b and 28c and the axis of rotation 24. In this case the length of the projections 29a, 29b and 29c would be zero.

Differing embodiments of the present invention are also possible having various numbers of flexibility discs 49 and reels 40, 41. The number of reels 80 (and 40, 41) and flexibility discs 49 can be selected to fit the requirements of a particular type of combine harvester. For example, the feeder roller may include between 2 to 5 reels 80 and/or 1 to 3 flexibility discs 49, depending on the application and type of machinery that the feeder roller is to be fitted within.

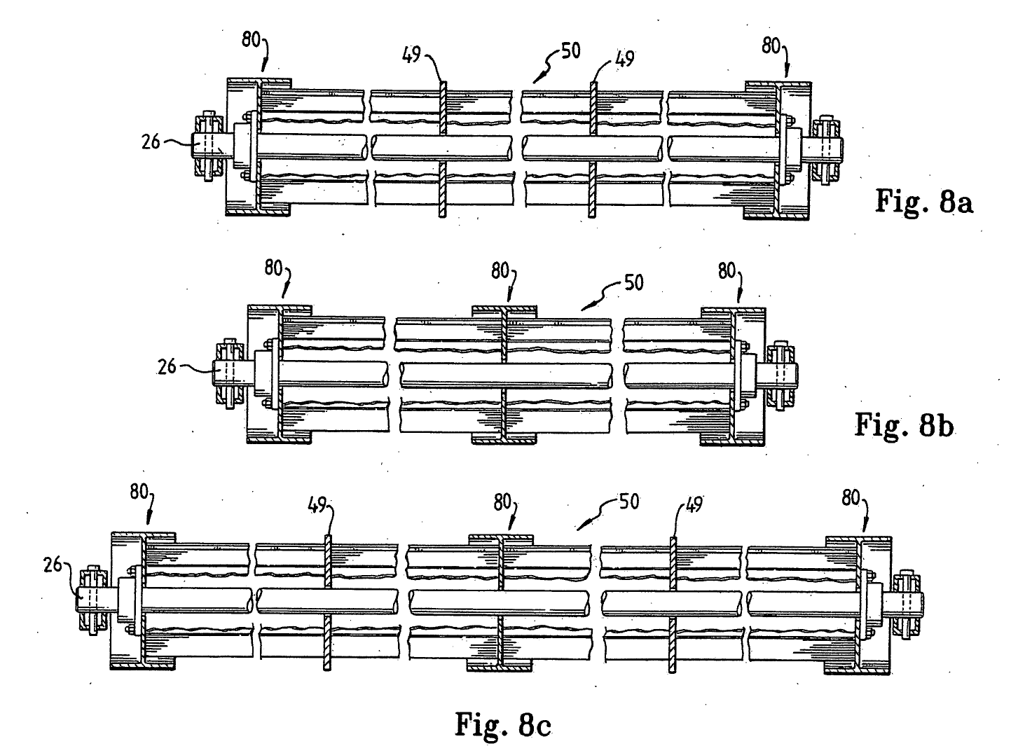

FIGS. 8a, 8b and 8c illustrate three examples of different embodiments of the invention. The feeder roller illustrated in FIG. 8a includes two reels 80 located at opposite end of the elongated section 50 and two flexibility discs 49 affixed one third and two thirds along the length of the elongated section 50. The feeder roller illustrated in figure 8b includes three reels 80 located at opposite end of the elongated section 50 and in the middle of the length of the elongated section 50. This embodiment is intended to fit a combine harvester elevator apparatus which uses three chains 11. The feeder roller illustrated in FIG. 8c includes three reels 80 located at opposite end of the elongated section 50 and in the middle of the length of the elongated section 50 and two flexibility discs 49 affixed one third and two thirds along the length of the elongated section 50. This embodiment is intended to fit a combine harvester elevator apparatus having a wide elevator chute and incorporating three or more chains 11. The width of the corresponding roller requires that two flexibility discs 49 are used between each successive reel 80 so as to prevent excessive flexing of the slats 12.

Other variations to the basic configuration of the feeder roller 20 of the present invention further include the addition of projections to the planar sheets 22a, 22b or 22c and different reel 40, 41 configurations.

In one embodiment of the present invention, the outer surface of planar sheets 22a, 22b or 22c include a projection at the point at which the constitute flat sheets 23a and 23b meet.

In another embodiment of the present invention, the projections may include teeth 70, as illustrated in FIG. 7. These teeth may be saw-toothed, circular, square or the like. In the illustrated embodiment, the teeth are substantially rectangular.

In another embodiment of the present invention, the reel 40 further includes a groove or channel 92 substantially around the circumferential face of the rim 47. This channel 92 can be used as a guide groove for the belt or chain 11 to sit within and engage the reel 40. In another embodiment of the present invention, the channel 92 is concave. In yet another embodiment of the present invention, the reel 40 is constructed out of tyre rim shaped body, in which the chain 11 runs within the tyre channel of the tyre rim.

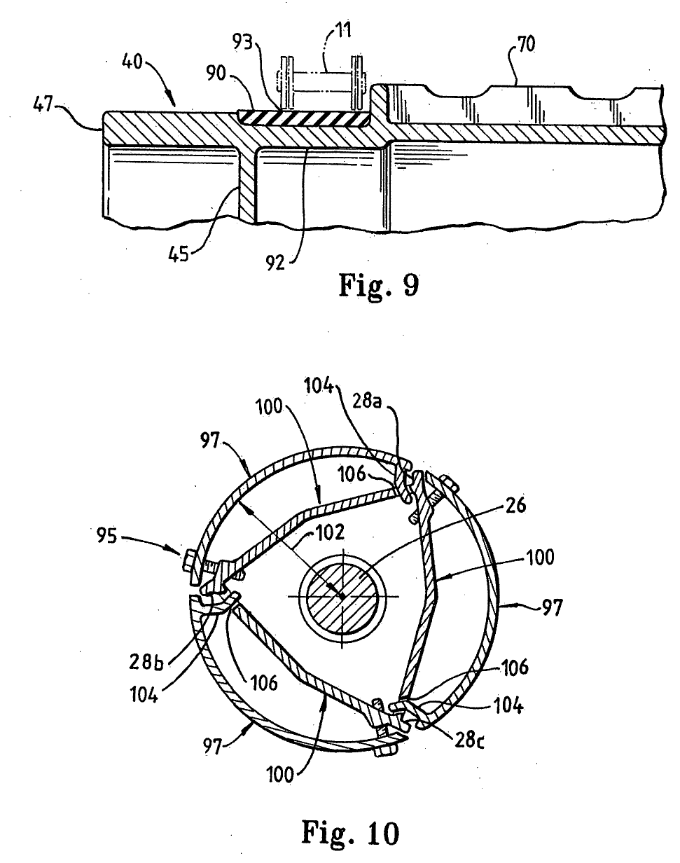

In another embodiment of the invention, an insert 90 is fitted around the circumferential face of the rim 47. As illustrated in FIG. 9, the insert 90 may be attached to the rim within a groove or channel 92 substantially around the circumferential face of the rim 47. The purpose of this insert 90 is primarily to dampen the contact point 93 between the chain 11 and reel rim 47, so that less noise is produced during operation when the chain 11 engages the rim 47. It is envisaged that the insert 90 would have to be made out of a very durable material which would endure a significant amount of wear resulting from the chain 11 rubbing against the outer surface of the insert 90. Suitable materials for use as the insert 90 include specialised polymers, ceramics or alloys.

In yet another embodiment of the present invention illustrated in FIG. 10, attachable covers 97 can be used to cover the planar sheets 22a, 22b and 22c of the elongated section 50. In the illustrated embodiment, the covers 97 comprises three tubular segments 97 having a cross-section perpendicular to the axis of rotation substantially equivalent to one third of a circle. The tubular segments 97 extend lengthwise across the entire length of the elongated section 50, from the reel 40 on one side of the feeder roller to the opposite end reel 41 on the other of the feeder roller. The tubular segments 97 surround the elongated section 50 to form a cylinder. Each tubular segment 97 has a radius 102 at least equal to the average distance of the three intersection locations 28a, 28b and 28c to the axis of rotation. The radius 102 of the tubular segment 97 can not exceed the radius of a cylinder defined by the top of the chain 11 when positioned above the top surface of the reels 40 or 21.

The tubular segments 97 can be attached to the elongated member 50 using any practical means. In the illustrated embodiment, each tubular segment 97 is constructed with a projection or latch 104 inside and at one end of the cover 97, which laterally projects from the internal surface of the cover 97. The latch 104 can be secured into a corresponding recess 106 within the structure of each of the planar sheets 100. The opposite side of the cover 97 can then be releasably secured into another part of the planar sheet 50 using an attachment means 95 such as bolts, clamps, clips, hooks, interlocking ribs or the like. In another embodiment of the invention, both sides of the tubular segments 97 are bolted onto the planar sheets 100 at various positions along the length of the elongated member 50.

When the tubular segments 97 attach along the length of the planar sheets 100, the tubular segments 97 surround the elongated member 50 in a substantially cylindrical cover. Preferably, the radius 102 of the cover 97 is substantially the same as the average distance between the axis of rotation 26 and each point of intersection between adjacent planar sheets 28a, 28b and 28c. The cover 97 can be constructed of any suitably durable material such as plastics, wood or metal. Preferably, the cover 97 is constructed from metal. Typically, the cover 97 is constructed of a gauze-like metal material.

In another embodiment of the present invention, the projections 29a, 29b and 29c extend a predetermined distance beyond the outer circumference of the covers 97. In another embodiment of the present invention, the covers 97 have a radius 102 less than the average distance between the axis of rotation 26 and each point of intersection between adjacent planar sheets 28a, 28b and 28c. Therefore, the covers 97 only partially cover the planar surfaces 100 of the elongated member 50.

In operation, the projections 29a, 29b and 29c of the feeder roller 20 help feed harvested crop 4 under the elevator 8. The operation of the feeder roller 20 in this respect can be seen in FIG. 2. Cut crop 4 is pushed towards the feeder roller 20 of an elevator 8 by the rotation of an auger 7. The cut crop 4 contacts the front roller 20 and/or slats 12 and is directed under the elevator 8. The projections 29a, 29b and 29c contact the cut crop 4 travelling out of the rotating auger 5, and in conjunction the slats 12, push or beat the cut crop 4 under feeder roller 20 and through the gap 15 between the bottom of said feeder roller 20 and the elevator chute floor 13A, directing the cut crop 4 under the elevator 8.

Accordingly, the projections 29a, 29b and 29c on the feeder roller 20 contact the cut crop 4 directed towards the feeder roller 20 at a particular point of contact and add a motion to the cut crop 4. The motion added to the cut crop 4 corresponds to the feeder roller's direction of rotation 30. Typically, the motion added to the cut crop 4 is in a substantially tangential direction to an arc formed by the rotation of a point of contact about the axis of rotation 24 of the feeder roller 20.

Therefore, the advantages of the present invention results from the projections 29a, 29b and 29c adding a pushing or beating action to cut crops 4, contacting the rotating feeder roller 20. In the illustrated embodiment, the planar sheets 22a, 22b and 22c enhance the beating action by providing an extended surface in which to contact the cut crop 4.

In this regard, it is noted that the embodiment of the present invention having attachable covers 97 uses the covers 97 to adjust the beating action of the planar sheets 100 of a feeder roller. In this respect covers can be placed over any amount of the planar surface area of the planar sheets 100, so as to reduce the contact area of the planar sheets 100 with the cut crop. When the covers 97 completely cover the planar sheets 100, such as illustrated in FIG. 1,the beating action of the feeder roller 20, is substantially the same as the beating action of a cylindrical feeder roller. Various sizes of covers could be fitted to cover a predetermined amount of the planar sheets 100. This has the advantage of allow the user the option of tailoring the configuration of the feeder roller 20 to the needs of the crops. For example, if the crops are grown in a field with excessive amounts of stones, it may be advantageous to reduce the beating action of the planar sheets 100, so as to reduce the possibility of feeding stones to the processing section 14 of the combine harvester. This could be achieved by fitting a suitably sized cover 97 over the planar sheets 100 of the elongated section 50.

It is envisaged that the present invention could be manufacture using any suitable technique known to a person skilled in the art. For example, the present invention may be fabricated by combining individual parts using welding techniques or the like, or may be cast in part or in its entirety.

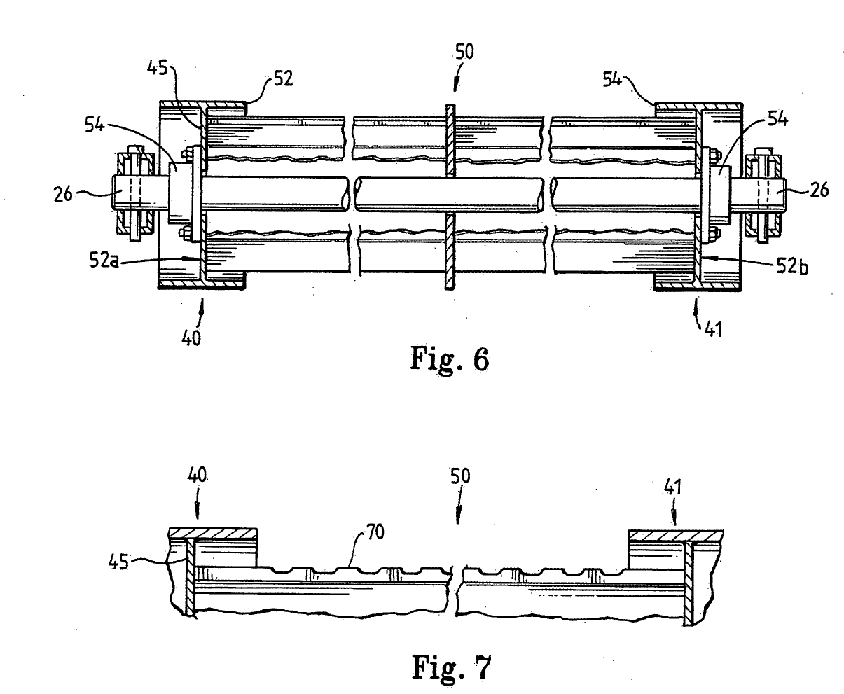

However, has been found that it is preferable that when the present invention is fabricated using flat sheets and welding techniques, that the present invention is made with minimum projection 29a, 29b and 29c length. In this respect, it is easier to connect the triangular elongated section 50 to the cylindrical reels 40, 41, if the projections 29a, 29b and 29c fit beneath the surface of the reels 52 and 54. Such an embodiment of the present invention is illustrated in FIG. 6.

It is also envisaged that the present invention could be manufactured from any suitably durable material such as plastics, metal, ceramics or wood. Preferably, the present invention is manufactured from a rigid material, more preferably a metal, and even more preferably, steel.

The described arrangement has been advanced by explanation and many modifications may be made without departing from the spirit and scope of the invention, which includes every novel feature and novel combination of features herein disclosed.

Those skilled in the art will appreciate that the invention described herein is susceptible to variations and modifications other than those specifically described. It is understood that the invention includes all such variations and modifications which fall within the spirit and scope.

1. A feeder roller for agricultural machinery which facilitates the feeding of an object or item from a first location to a second location, the feeder roller being rotatable about an axis of rotation and having an outer surface which includes at least one projection which extends a predetermined distance from the outer surface in an outwardly direction away from the axis of rotation.

2. A feeder roller according to claim 1, in which the outer surface includes a plurality of projections.

3. A feeder roller according to claim 2, in which the projections are evenly distributed over the outer surface of the feeder roller.

4. A feeder roller according to claim 1, in which the projections are elongated in a direction parallel to the axis of rotation.

5. A feeder roller according to claim 4, in which the projections are shaped as rectangular parallelepipeds.

6. A feeder roller according to claim 1, in which the shape of the projections are adapted to include teeth.

7. A feeder roller according to claim 1, in which the feeder roller comprises an elongated section in the form of a cylinder, parallelepiped or prism having a length parallel with the axis of rotation.

8. A feeder roller according to claim 7, in which the elongated section has a substantially triangular cross-section perpendicular to the axis of rotation.

9. A feeder roller according to claim 1, in which the feeder roller comprises at least three substantially planar members which extend lengthwise around the axis of rotation forming vertices of a prism.

10. A feeder roller according to claim 9, in which each planar member includes at least two spaced apart intersection locations parallel to the axis of rotation in which part of one planar member intersects with a part of another planar member which meet at a peak or point and thereby form a projection.

11. A feeder roller according to claim 10, in which each intersection location includes at least one projection.

12. A feeder roller according to claim 1, further comprising an actuating section which includes at least one belt or chain driven section.

13. A feeder roller according to claim 12, in which the actuating section comprises at least one cylindrical section perpendicular to the axis of rotation such that the axis of symmetry of the cylindrical section is equivalent to the axis of rotation of the feeder roller.

14. A feeder roller according to claim 13, in which at least one of the cylindrical sections is a belt or chain driven section.

15. A feeder roller according to claim 14, in which the a belt or chain driven cylindrical section further includes a groove or channel substantially around the circumferential face adapted to engage the belt or chain of the actuating section.

16. A feeder roller according to claim 15, in which the groove or channel includes a material insert or coating which dampens noise caused by the belt or chain engaging the chain driven section.

17. A feeder roller according to claim 1, further comprising attachable covers which attach along the length of the feeder roller.

18. A feeder roller according to claim 17, in which the covers attach to the feeder roller so as to form a substantially cylindrical cover around the feeder roller.

19. A feeder roller according to claim 18, in which at least one projection extends a predetermined distance in an outwardly direction from the axis of rotation, beyond the cover's outer circumference.

20. A combine harvester including a feeder roller according to claim 1.
